(19) United States
(12) Patent Application Publication
(10) Pub. No.: US 2005/0066103 A1
(43) Pub. Date: Mar. 24, 2005

(54) PC card device with indicator having good visibility

(75) Inventor: Akio Shinozaki, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 10/933,415

(22) Filed: Sep. 3, 2004

(30) Foreign Application Priority Data
Sep. 8, 2003 (JP) 2003-315028

(51) Int. Cl. G06F 13/00

(52) U.S. Cl. 710/301

(57) ABSTRACT

A personal computer card device has a pair of operation state indicating portions exposed at front and back surfaces of a projecting part of a body thereof. The projecting part is projected from a chassis of an information apparatus when the personal computer card device is partly inserted in to a card slot of the information apparatus. Light emitted from a single light emitting device housed in the body is guided by a light guiding member to the operation state indicating portions. Thus, an operation state of the personal computer card device can be seen from both of front and back surface sides.

This application claims priority to prior Japanese application JP 2003-315028, the disclosure of which is incorporated herein by reference.

### BACK GROUND OF THE INVENTION

This invention relates to a personal computer (PC) card device in conformity with standards of Personal Computer Memory Card International Association (PCMCIA).

The PC card device is partly inserted into a card slot provided in an information apparatus such as a personal computer or a personal digital assistance (PDA) and coupled to the information apparatus to serve as a peripheral device for the information apparatus.

A related PC card device has an operation state indicator to indicate an operation state thereof. The operation state indicator is designed to be seen from a specific direction when the PC card device is combined with a notebook computer which is in normal use condition. That is, the operation state indicator can be seen from above when the PC card device is partly inserted into the card slot of the notebook computer which is located on a desk in the normal use condition.

On the other hand, the PDA is held by a hand of a user in normal use condition differently from the notebook computer. Accordingly, there is a type of PDA having a different card slot than that of the notebook computer in direction. When such a type of PDA is combined with the PC card device, the operation state indicator is directed in the same direction as the user. In this case, the user can not see the operation state indicator in the condition that the PDA is in the normal use condition. In other words, the user must turns over the PDA to see the indicator of the PC card device inserted in the card slot of the PDA.

Thus, the related PC card device has a problem that the indicator has poor visibility according to a type/kind of information apparatus with which the PC card device is combined.

### SUMMARY OF THE INVENTION

It is therefore an object of this invention to provide a PC card device has a good visibility regardless of a type/kind of information apparatus to which the PC card is connected.

Other object of this invention will become clear as the description proceeds.

According to an aspect of this invention, a personal computer card device comprises a body for being partly inserted in a card slot of an information apparatus. The body has a projecting part which projects from the card slot when the body is partly inserted in the card slot. An operation state indicator is for indicating an operation state of the personal computer card device. The operation state indicator includes a pair of operation state indicating portions exposed at front and back surfaces of the projecting part of the body.

The operation state indicator may have a light emitting device to emit light. A light guiding member is for guiding the light from the light emitting device to both of the operation state indicating portions.

### BRIEF DESCRIPTION OF THE DRAWINGS

FIG. 1A is a plane view of a related personal computer card device inserted in a card slot of an information apparatus;

FIG. 1B is a side view of the related personal computer card device of FIG. 1A;

FIG. 1C is a bottom plan view of the related personal computer card device of FIG. 1A;

FIG. 1D is a sectional view taken along a line D1-D1′ in FIG. 1A;

FIG. 2A is a plane view of a personal computer card device, which is inserted in a card slot of an information apparatus, according to first embodiment of this invention;

FIG. 2B is a side view of the personal computer card device of FIG. 2A;

FIG. 2C is a bottom plan view of the personal computer card device of FIG. 2A;

FIG. 2D is a sectional view taken along a line D2-D2′ in FIG. 2A;

FIG. 3A is a plane view of a personal computer card device, which is inserted in a card slot of an information apparatus, according to second embodiment of this invention;

FIG. 3B is a side view of the personal computer card device of FIG. 3A;

FIG. 3C is a bottom plan view of the personal computer card device of FIG. 3A;

FIG. 3D is a sectional view taken along a line D3-D3′ in FIG. 3A;

FIG. 4 is a partial plane view of a personal computer card device according to other embodiment of this invention.

### PREFERABLE EMBODIMENTS

The description will be at first directed to a related personal computer (PC) card device having an operating state indicator for good understanding of this invention.

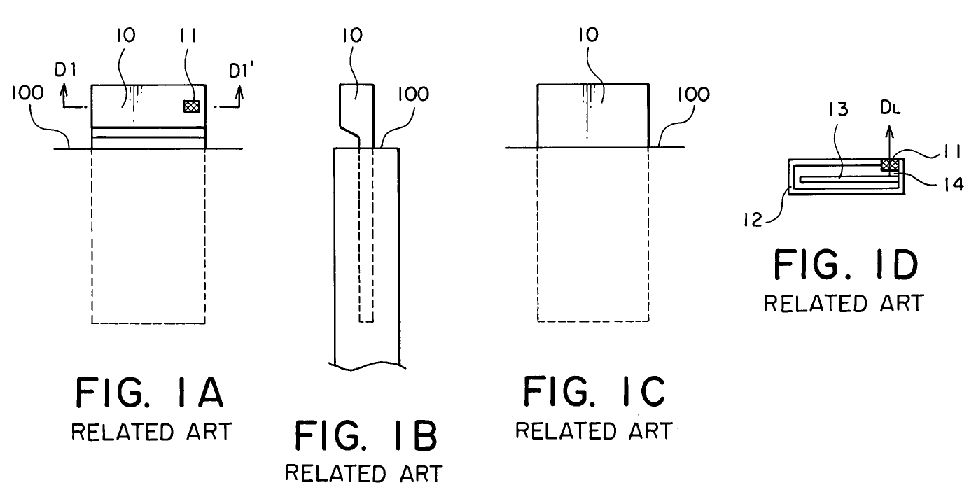

FIGS. 1A-1D are diagrams of the related PC card device 10 inserted in a card slot (not shown) of an information apparatus 100 such as a notebook computer. FIGS. 1A-1C are drawn as though looking from a front side, a lateral side and a backside, respectively. FIG. 1D shows a sectional view taken along a D1-D1′ line of FIG. 1A.

As understood from FIGS. 1A-1C, a body of the PC card device 10 has a projecting part projected from a chassis of the information apparatus 100 when the PC card is partly inserted in the card slot and attached to the information apparatus 100. The projecting part of the PC card device 10 has an operation state indicating portion 11 exposed at a front surface thereof.

Furthermore, as understood from FIG. 1D, the PC card device 10 has a case 12 and a circuit board 13 housed in the case 12. The circuit board 13 provides a prescribed circuit (not shown) and an LED 14 for indicating an operation state of the prescribed circuit of the PC card device 10.

With the structure mentioned above, light emitted from the LED 14 penetrates the operation state indicating portion 11 and thereby it is radiated from the front surface of the PC card device 10 to the outside as shown by an arrow DL in FIG. 1D. As a result, a user can see the operation state of the PC card device 10.

Additionally, there is another related PC card device (not shown) having an operation state indicating portion extending from a front surface to an upper side surface (corresponding to upper sides of FIGS. 1A to 1C) to be seen from not only a front side but also an upper side. Such a PC card device is disclosed in Japanese Unexamined Patent Publication No. 11-41366.

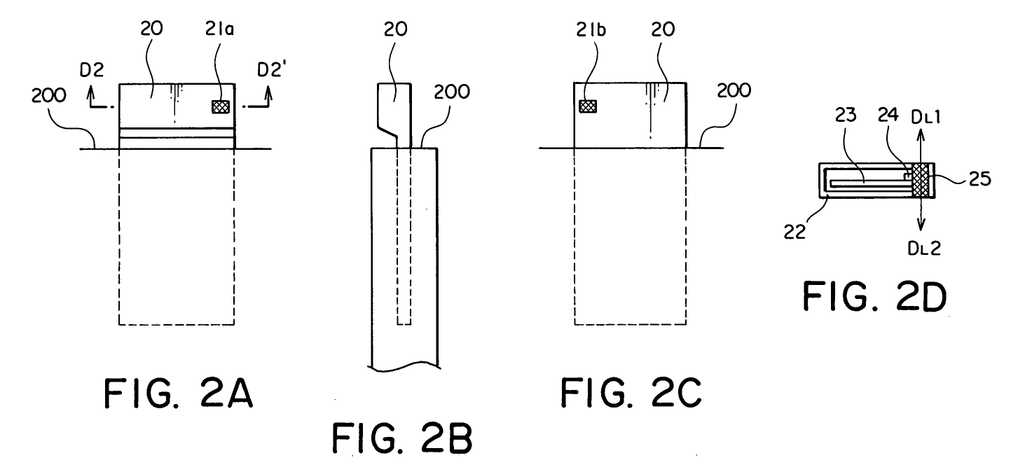

Referring to FIGS. 2A to 2D, the description will be made about a PC card device according to a first embodiment of this invention.

FIGS. 2A-2D are diagrams of the PC card device 20 inserted in a card slot (not shown) of an information apparatus 200 such as a notebook computer. FIGS. 2A-2C are drawn as though looking from a front side, a lateral side and a back side, respectively. FIG. 2D shows a sectional view taken along a D2-D2′ line of FIG. 2A.

As understood from FIGS. 2A-2C, a body of the PC card device 20 has a projecting part projected from a chassis of the information apparatus 200 when it is partly inserted into the card slot and attached/coupled to the information apparatus 200. The projecting part of the PC card device 20 has a pair of operation state indicating portions 21a and 21b exposed at front and back surfaces thereof, respectively. Preferably, the operation state indicating portions 21a and 21b form the same plane as the front and the back surfaces of the projecting part.

Furthermore, as understood from FIG. 2D, the PC card device 20 has a case 22 and a circuit board 23 housed in the case 22. The circuit board 23 provides a prescribed circuit (not shown) and a light emitting element (or an LED) 24 for indicating an operation state of the prescribed circuit of the PC card device 20. The LED 24 is placed on the circuit board 23 to emit light at least in a direction parallel to a main surface of the circuit board 23 (or to the right of FIG. 1D).

In addition, the PC card device 20 has a light guiding member 25 arranged near to the LED 24 to receive the light from the LED 24. The light guiding member 25 perforates the body (or the case 22) of the PC card device 20 and extends from the front surface to the back surface of the body. Upper and lower end surfaces of the light guiding member 25 are exposed at the front and the back surfaces of the PC card device 20 and serve as the operation state indicating portions 21a and 21b, respectively. The light guiding member 25 is made of, for example, transparent synthetic resin.

With the structure mentioned above, the light emitted from the LED 24 is reflected many times in the light guiding member 25 and guided to the front and the back surfaces of the PC card device 20 to be radiated to the outside from the operation state indicating portions 21a and 21b as shown by arrows DL1 and DL2 in FIG. 2D.

Thus, the operation state of the PC card device 20 can be seen (or recognized) from both of the front and the back surface sides of the PC card device 20. Accordingly, the operation state of the PC card device 20 can be seen regardless of the type/kind (or the attaching direction) of the card slot provided in the information apparatus 200 when the information apparatus 200 is used in the normal using state.

Furthermore, the PC card device 20 is inexpensive in comparison with a case where two light emitting elements are used for the front and the back surface sides. This is because the PC card device 20 is configured so that the light emitted from the single light emitting element (or LED) 24 is guided to both of the front and the back surface sides of the PC card device 20.

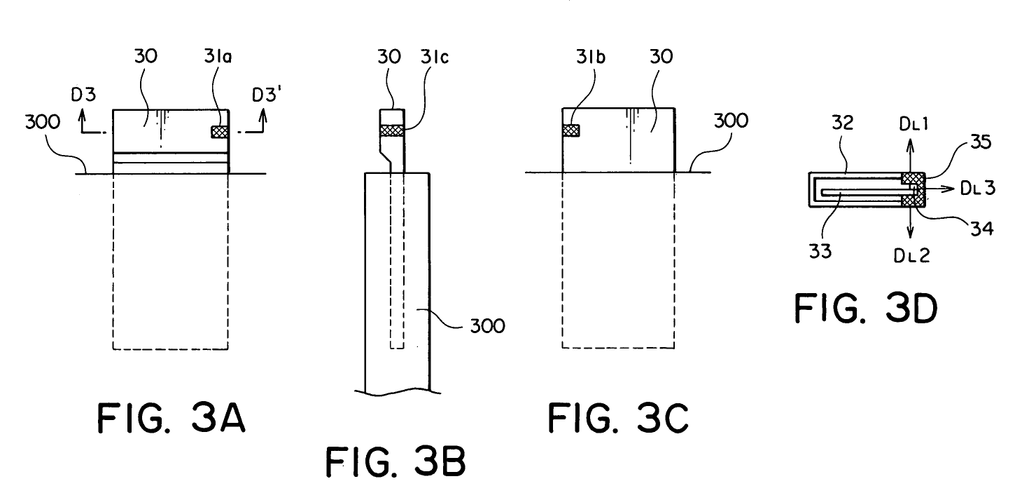

Referring to FIGS. 3A to 3D, the description will be made about a PC card device according to a second embodiment of this invention.

FIGS. 3A-3D are diagrams of the PC card device 30 inserted in a card slot (not shown) of an information apparatus 300 such as a notebook computer. FIGS. 3A-3D correspond to FIGS. 2A-2D while reference numerals 20-25 and 200 correspond to the reference numerals 30-35 and 300, respectively.

As understood from FIGS. 3A-3D, the PC card device 30 includes a light guiding member 35 having a horseshoe shape in section to form the same surfaces as the front, the back and the lateral side surfaces. In other words, the light guiding member 35 is exposed from the front surface to the back surface via a lateral side surface to serve operation state indicating portions 31a, 31b and 31c.

With this structure, light emitted from an LED 34 is reflected many times in the light guiding member 35 and guided to not only both of the front and the back surfaces of the PC card device 30 but also the lateral side surface to be radiated to the outside from the operation state indicating portions 31a, 31b and 31c as shown arrows DL1-DL3.

Thus, the operation state of the PC card device 30 can be seen (or recognized) from the front, the lateral side and the back surface sides. Accordingly, the operation state of the PC card device 30 can be seen regardless of the type/kind (or the attaching direction) of the card slot provided in the information apparatus 300 when the information apparatus 300 is used in the normal using state.

Furthermore, the PC card device 30 is inexpensive because it is configured so that the light emitted from the single light emitting element (or LED) 35 is guided to all of the front, the lateral side and the back surface sides of the PC card device 30.

While this invention has thus far been described in conjunction with the preferred embodiments thereof, it will readily be possible for those skilled in the art to put this invention into practice in various other manners.

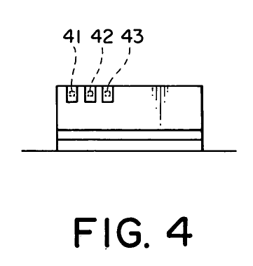

For example, the light guiding member 25 is not always made as one part and may include two parts for the front and the back surface sides. Similarly, the light guiding member 35 is not always made as one part and may includes two or more parts. Furthermore, the light guiding member 35 may be exposed from the front surface to the back surface via an upper side surface as illustrated in FIG. 4. Additionally, as shown in FIG. 4, the operation state indicator may have two or more light emitting devices (41-43) together with corresponding operation state indicating portions. The plural light emitting devices are used to indicate different contents of the operation state of the PC card device.

1. A personal computer card device comprising:
a body for being partly inserted in a card slot of an information apparatus, said body having a projecting part projecting from said card slot when said body is partly inserted in said card slot; and
an operation state indicator for indicating an operation state of said personal computer card device, wherein:
said operation state indicator includes a pair of operation state indicating portions exposed at front and back surfaces of said projecting part of said body.

2. A personal computer card device as claimed in claim 1, wherein said operation state indicator comprises:
a light emitting device for emitting light;
a light guiding member for guiding the light from said light emitting device to both of said operation state indicating portions.

3. A personal computer card device as claimed in claim 2, wherein said light guiding member has parts to serve as said operating state indicating portions.

4. A personal computer card device as claimed in claim 2, wherein said light guiding member with a pair of end faces perforates said projecting part of said body so that said end faces serve as said operating state indicating portions.

5. A personal computer card device as claimed in claim 4, wherein said end faces form same planes as said front and said back surfaces.

6. A personal computer card device as claimed in claim 2, wherein said light guiding member has a horseshoe shape in section to be exposed from said front surface to said back surface via a side surface of said projecting part.

7. A personal computer card device as claimed in claim 2, wherein said light guiding member is made of transparent synthetic resin.

8. A personal computer card device as claimed in claim 1, wherein said operation state indicator further comprises an additional light emitting device and an additional operation state indicator corresponding to said additional operation state indicator.
